(19) United States
(12) Patent Application Publication
(10) Pub. No.: US 2010/0150226 A1
(43) Pub. Date: Jun. 17, 2010

(54) SWITCHING BETWEEN DCT COEFFICIENT CODING MODES

(75) Inventors: Antti Olli Hallapuro, Tampere (FI); Jani Lainema, Tampere (FI); Kemal Ugur, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/630,763

(22) Filed: Dec. 3, 2009

Related U.S. Application Data
(60) Provisional application No. 61/119,696, filed on Dec. 3, 2008.

(51) Int. Cl. H04N 7/26

(52) U.S. Cl. 375/240.03; 375/240.2; 375/E07.139

(57) ABSTRACT

A system and method is provided for improving efficiency when entropy coding a block of quantized transform coefficients in video coding. Quantized coefficients are coded in two separate coding modes, namely, a run mode to a level mode coding mode. “Rules” for switching between these two modes are provided, and various embodiments are realized by allowing an entropy coder to adaptively decide when to switch between the two coding modes based on context information, the rules and/or by explicitly signaling the position of switching (e.g., whether or not it should switch coding modes).

### RELATED APPLICATIONS

The present invention was first filed as U.S. Patent Application 61/119,696 filed on Dec. 3, 2008, which is incorporated herewith by reference in its entirety.

### FIELD

The present invention relates to the coding and decoding of digital video and image material. More particularly, the present invention relates to the efficient coding and decoding of transform coefficients in video and image coding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video encoder transforms input video into a compressed representation suited for storage and/or transmission. A video decoder uncompresses the compressed video representation back into a viewable form. Typically, the encoder discards some information in the original video sequence in order to represent the video in a more compact form, i.e., at a lower bitrate.

Conventional hybrid video codecs, for example ITU-T H.263 and H.264, encode video information in two phases. In a first phase, pixel values in a certain picture area or “block” of pixels are predicted. These pixel values can be predicted, for example, by motion compensation mechanisms, which involve finding and indicating an area in one of the previously coded video frames that corresponds closely to the block being coded.

Alternatively, pixel values can be predicted via spatial mechanisms, which involve using the pixel values around the block to estimate the pixel values inside the block. A second phase involves coding a prediction error or prediction residual, i.e., the difference between the predicted block of pixels and the original block of pixels. This is typically accomplished by transforming the difference in pixel values using a specified transform (e.g., a Discrete Cosine Transform (DCT) or a variant thereof), quantizing the transform coefficients, and entropy coding the quantized coefficients. By varying the fidelity of the quantization process, the encoder can control the balance between the accuracy of the pixel representation (i.e., the picture quality) and the size of the resulting coded video representation (i.e., the file size or transmission bitrate). It should be noted that with regard to video and/or image compression, it is possible to transform blocks of an actual image and/or video frame without applying prediction.

The entropy coding mechanisms, such as Huffman coding, arithmetic coding, exploit statistical probabilities of symbol values representing quantized transform coefficients to assign shorter codewords to more probable signals. Furthermore, to exploit correlation between transform coefficients, pairs of transform coefficients may be entropy coded. Additionally, adaptive entropy coding mechanisms typically achieve efficient compression over broad ranges of image and video content. Efficient coding of transform coefficients is a significant part of the video and image coding codecs in achieving higher compression performance.

### SUMMARY OF VARIOUS EMBODIMENTS

In accordance with one embodiment, the position and the value of the last non-zero coefficient of the block is coded, after which, the next coefficient grouping, e.g., (run, level) pair, is coded. If the cumulative sum of amplitudes (excluding the last coefficient) that are bigger than 1 is less than a predetermined constant value, and the position of the latest non-zero coefficient within the block is smaller than a certain location threshold, the next pair is coded. These processes are repeated until the cumulative sum of amplitudes (excluding the last coefficient) that are bigger than 1 is no longer less than the predetermined constant value, and/or the position of the latest non-zero coefficient within the block is no longer smaller than the certain location threshold. When this occurs, the rest of the coefficients are coded in level mode.

In accordance with another embodiment, the position and the value of the last non-zero coefficient of the block is coded, after which, the next coefficient grouping, e.g., (run,level) pair is coded. If the amplitude of the current level is greater than 1, it is indicated in the bitstream whether or not the code should continue coding in run mode or whether the coder is to switch to level mode. If run mode is indicated, the process continues and the next pair is coded. Otherwise, the rest of the coefficients are coded in level mode.

Various embodiments described herein improve earlier solutions to coding transform coefficients by defining more accurately, the position where switching from one coding mode to another should occur. This in turn improves coding efficiency. Signaling the switching position explicitly further enhances coding efficiency by directly notifying the coder where to switch coding modes.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 is a block diagram of a conventional video encoder;

FIG. 2 is a block diagram of a conventional video decoder;

FIG. 3 illustrates an exemplary transform and coefficient coding order;

FIG. 4 is a flow chart illustrating various processes performed for the coding of DCT coefficients in accordance with one embodiment;

FIG. 5 is a flow chart illustrating various processes performed for the coding of DCT coefficients in accordance with another embodiment;

FIG. 6 is a representation of a generic multimedia communications system for use with various embodiments of the present invention;

FIG. 7 is a perspective view of an electronic device that can be used in conjunction with the implementation of various embodiments of the present invention; and

FIG. 8 is a schematic representation of the circuitry which may be included in the electronic device of FIG. 7

### DETAILED DESCRIPTION OF VARIOUS EMBODIMENTS

Various embodiments are directed to a method for improving efficiency when entropy coding a block of quantized transform coefficients (e.g., DCT coefficients) in video and/or image coding. Quantized coefficients are coded in two separate coding modes, run mode coding and level mode coding. “Rules” for switching between these two modes are also provided, and various embodiments are realized by allowing an entropy coder to adaptively decide when to switch between the two coding modes based on context information and the rules and/or by explicitly signaling the position of switching (e.g., explicitly informing the entropy coder whether or not it should switch coding modes).

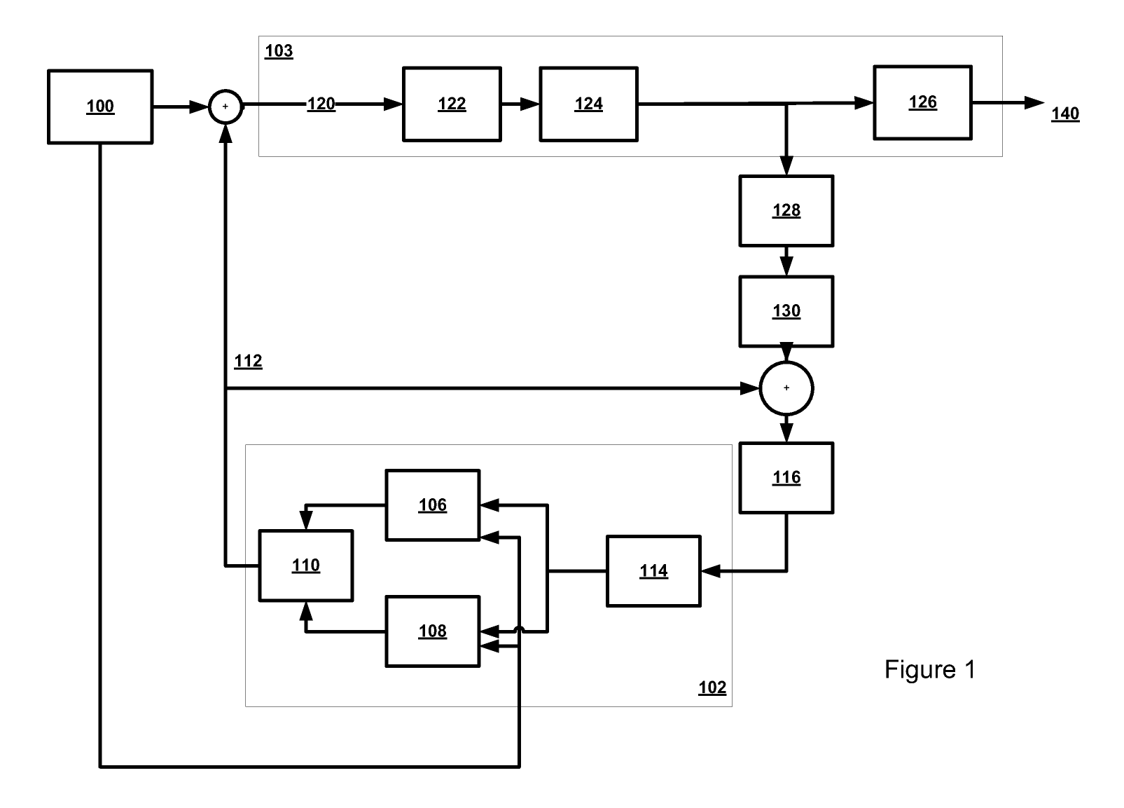

FIG. 1 is a block diagram of a conventional video encoder. More particularly, FIG. 1 shows how an image to be encoded 100 undergoes pixel prediction 102, and prediction error coding 103. For pixel prediction 102, the image 100 undergoes either an inter-prediction 106 process, an intra-prediction 108 process, or both. Mode selection 110 selects either one of the inter-prediction and the intra-prediction to obtain a predicted block 112. The predicted block 112 is then subtracted from the original image 100 resulting in a prediction error, also known as a prediction residual 120. In intra-prediction 108, previously reconstructed parts of the same image 100 stored in frame memory 114 are used to predict the present block. In inter-prediction 106, previously coded images stored in frame memory 114 are used to predict the present block. In prediction error coding 103, the prediction error/residual 120 initially undergoes a transform operation 122. The resulting transform coefficients are then quantized at 124.

The quantized transform coefficients from 124 are entropy coded at 126. That is, the data describing prediction error and predicted representation of the image block 112 (e.g., motion vectors, mode information, and quantized transform coefficients) are passed to entropy coding 126. The encoder typically comprises an inverse transform 130 and an inverse quantization 128 to obtain a reconstructed version of the coded image locally. Firstly, the quantized coefficients are inverse quantized at 128 and then an inverse transform operation 130 is applied to obtain a coded and then decoded version of the prediction error. The result is then added to the prediction 112 to obtain the coded and decoded version of the image block. The reconstructed image block may then undergo a filtering operation 116 to create a final reconstructed image 140 which is sent to a reference frame memory 114. The filtering may be applied once all of the image blocks are processed.

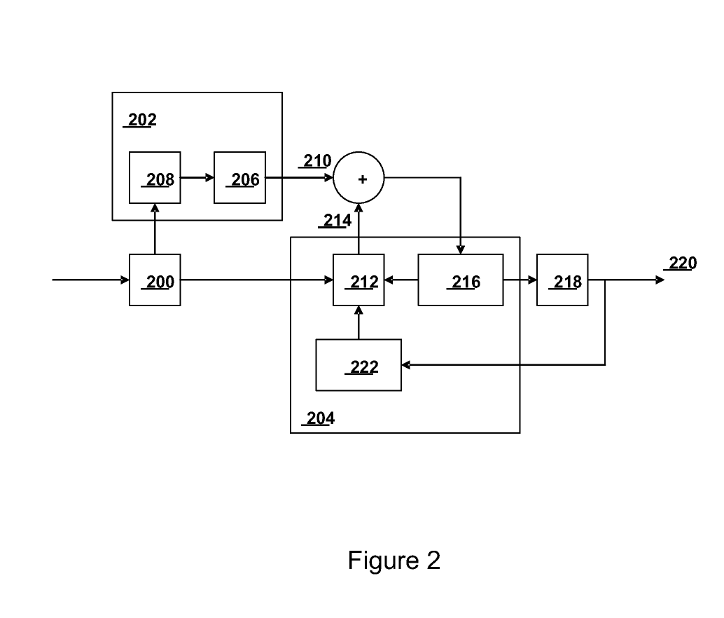

FIG. 2 is a block diagram of a conventional video decoder. As shown in FIG. 2, entropy decoding 200 is followed by both prediction error decoding 202 and pixel prediction 204. In prediction error decoding 202, an inverse quantization 206 and inverse transform 208 is used, ultimately resulting in a reconstructed prediction error signal 210. For pixel prediction 204, either intra-prediction or inter-prediction occurs at 212 to create a predicted representation of an image block 214. The predicted representation of the image block 214 is used in conjunction with the reconstructed prediction error signal 210 to create a preliminary reconstructed image 216, which in turn can be used for inter-prediction or intra-prediction at 212. Filtering 218 may be applied either after the each block is reconstructed or once all of the image blocks are processed. The filtered image can either be output as a final reconstructed image 220, or the filtered image can be stored in reference frame memory 222, making it usable for prediction 212.

The decoder reconstructs output video by applying prediction mechanisms that are similar to those used by the encoder in order to form a predicted representation of the pixel blocks (using motion or spatial information created by the encoder and stored in the compressed representation). Additionally, the decoder utilizes prediction error decoding (the inverse operation of the prediction error coding, recovering the quantized prediction error signal in the spatial pixel domain). After applying the prediction and prediction error decoding processes, the decoder sums up the prediction and prediction error signals (i.e., the pixel values) to form the output video frame. The decoder (and encoder) can also apply additional filtering processes in order to improve the quality of the output video before passing it on for display and/or storing it as a prediction reference for the forthcoming frames in the video sequence.

In conventional video codecs, motion information is indicated by motion vectors associated with each motion-compensated image block. Each of these motion vectors represents the displacement of the image block in the picture to be coded (in the encoder side) or decoded (in the decoder side) relative to the prediction source block in one of the previously coded or decoded pictures. In order to represent motion vectors efficiently, motion vectors are typically coded differentially with respect to block-specific predicted motion vectors. In a conventional video codec, the predicted motion vectors are created in a predefined way, for example by calculating the median of the encoded or decoded motion vectors of adjacent blocks.

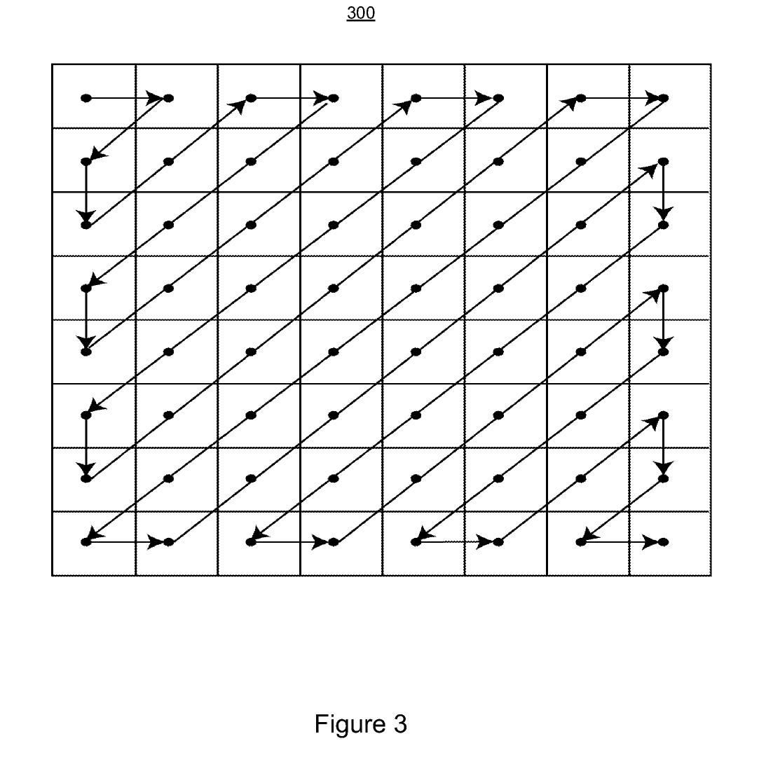

FIG. 3 illustrates an 8×8 block of transform coefficients 300. 8×8 transform coefficients are obtained by transforming pixels or prediction residuals. FIG. 3 illustrates zig-zag scanning of an 8×8 block of transform coefficients 300. Ordering of the transform coefficients can begin at the top left corner of the block (with the lowest frequency coefficients) and proceed in, e.g., a zig-zag fashion, to the bottom right corner of the block (with the highest frequency coefficients). The two-dimensional array of coefficients may then be scanned (following the zig-zag pattern) to form a 1-dimensional array. These coefficients may then be coded in reverse order, e.g., from last to first, with the last coefficient having an index value of 0. It should be noted that other transform types, transform size, and/or scanning order are possible, as well as the interleaving of the coefficients. After zig-zag scanning, each non zero coefficient is represented by a (run, level) pair where run value indicates the number of consecutive zero values and level value indicates the value of the non-zero coefficient.

In accordance with various embodiments, it is assumed that there is at least one non-zero coefficient in the block to be coded. Coefficients are generally coded in a last to first coefficient order, where higher frequency coefficients are coded first. However, coding in any other order may be possible. If at any point during the coding process there are no more coefficients to be coded in the block, an end of block notification is signaled, if needed, and coding is stopped for the current block.

One method of entropy coding involves adaptively coding transform coefficients using two different modes. In a first mode referred to as “run” mode, coefficients are coded as (run,level) pairs. That is, a “run-level” refers to a run-length of zeros followed by a non-zero level, where quantization of transform coefficients generally results in higher order coefficients being quantized to 0. If the next non-zero coefficient has an amplitude greater than 1, the codec switches to a “level” mode. In the level mode, remaining coefficients are coded one-by-one as single values, i.e. the run values are not indicated in this mode.

For example, quantized DCT coefficients of an 8×8 block may have the following values.

$$\begin{matrix}2 & 0 & 0 & 1 & 0 & 0 & 0 & 0 \\ - 2 & 1 & 0 & 0 & 0 & 0 & 0 & 0 \\ 0 & 0 & 0 & - 1 & 0 & 0 & 0 & 0 \\ 1 & 1 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}$$

Quantized DCT coefficients are ordered into a 1-D table as depicted in FIG. 3, resulting in the following list of coefficients.

2 0-2 0 1 0 1 0 0 1 0 1 0 0 0 0 0-1 0 . . . 0

The ordered coefficients are coded in reverse order starting from the last non-zero coefficient. First, the position and the value (−1) of the last-non-zero coefficient is coded. Then, the next coefficients are coded in the run mode resulting in the following sequences of coded (run,level) pairs.

$$\begin{matrix}000001 & ( run = 5 , level = 1 ) \\ 01 & ( run = 1 , level = 1 ) \\ 001 & ( run = 2 , level = 1 ) \\ 01 & ( run = 1 , level = 1 ) \\ 0 - 2 & ( run = 1 , level = - 2 )\end{matrix}$$

Since the latest coded coefficient had an amplitude greater than 1, the coder switches to the level mode. In the level mode, the remaining coefficients (0 and 2) are coded one at a time after which the coding of the block is finished.

Such a coding scheme often results in the switching to level mode even if it would be beneficial to continue in the run mode (e.g., the number of bits produced by the codec would be fewer when continuing in run mode). This is because run coding is based upon coding information about runs of identical numbers instead of coding the numbers themselves. Switching between the modes may happen at a fixed position or at any point not implicitly determined.

In one embodiment, the position and the value of a last non-zero coefficient of the block is coded. If the amplitude of the last coefficient is greater than 1, the process proceeds to level coding. Otherwise, the next (run,level) pair is coded. If the amplitude of the current level is equal to 1, the coding process returns to the previous operation and the next pair is coded. Lastly, the rest of the coefficients are coded in level mode.

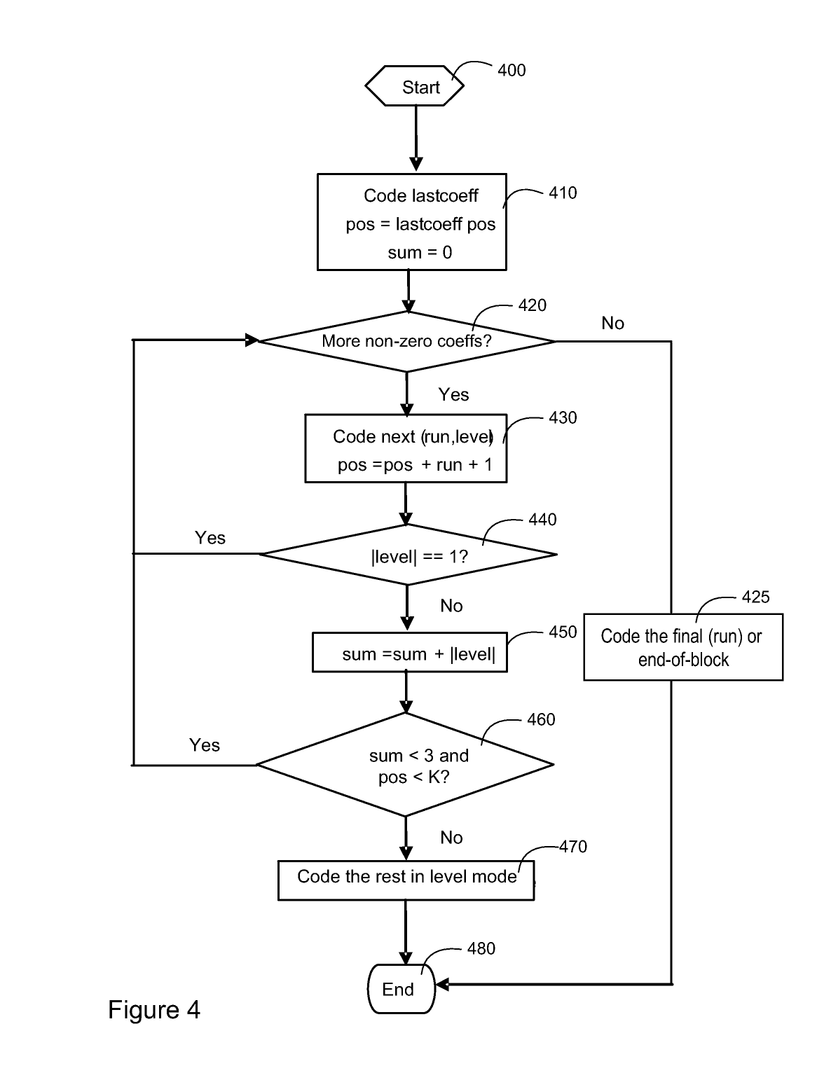

FIG. 4 illustrates a further exemplary coding method in accordance with one embodiment resulting in greater efficiency than that possible with the above-described method of coding. At 400, a coding operation in accordance with the one embodiment starts. At 410, the position and value of a last non-zero coefficient of a block is coded. It should be noted that this particular coding of the last non-zero coefficient of the block is not coded according to either a run or level coding mode. At 420, it is determined whether there are remaining non-zero coefficients to be coded. If there are no more coefficients to be coded, the final (run) or end-of-block is coded at 425, and the operation is stopped at 480. At 430, if more coefficients exist, the next coefficient, e.g., (run,level) pair, is coded. At 440, it is determined whether the amplitude of the current level is equal to 1, and if so, the operation returns to 420 and the next pair is coded at 430. It should be noted that a different minimum amplitude threshold value than “1” may be used at 440 and subsequent processes. If the amplitude of the current level does not equal 1, at 450, the cumulative sum of amplitudes (excluding that of the last coefficient) is determined for those coefficients with an amplitude greater than 1. At 460, it is determined whether the cumulative sum of amplitudes (excluding the last coefficient) that are bigger than 1 is less than a cumulative threshold L (e.g., 3) and whether the position of the latest non-zero coefficient within the block is smaller than K, and if so, the operation repeats itself by returning to 420 and coding the next pair at 430. If at 460, it is determined that the cumulative sum of amplitudes (excluding the last coefficient) that are bigger than 1 is not less than the cumulative threshold L and/or the position of the latest non-zero coefficient within the block is not smaller than K, the remaining coefficients are coded in level mode at 470. Once no more coefficients remain to be coded, the operation is stopped at 480. It should be noted that the determination at 460 (whether the cumulative sum of amplitudes of previously coded non-zero coefficients are greater than the minimum amplitude threshold) may be met by a current level having an amplitude that is greater than 2. Additionally, the determination may be met at least by meeting a maximum number of occurrences for any amplitude value of one of the previously coded non-zero coefficients. For example, if there is an occurrence of two coefficients, each of which have an amplitude equal to 2, the resulting cumulative sum of amplitudes (excluding the last coefficient) that are larger than 1 will exceed the cumulative threshold value of 3. That is, and to generalize, switching between coding modes can be based upon position and a cumulative sum of amplitudes or upon position and the occurrence of amplitudes, where the maximum number of occurrences is defined individually for each amplitude level.

Various embodiments utilize multiple coefficients to decide whether or not to switch between run and level coding modes. Furthermore, various embodiments consider the position of the coefficients as part of the switching criterion. It should be noted that a cumulative threshold value of 3 is chosen according to empirical tests. However, other values could be used, where, e.g., the cumulative threshold L is made to depend on a quantization parameter (QP) value to reflect the changing statistics of different quality levels. Similarly, the value for the location threshold K can vary (e.g., based on the QP used in coding the block, coding mode of the block or the picture). Moreover, although the two modes described herein are the run mode and level mode, any two coding modes can be used.

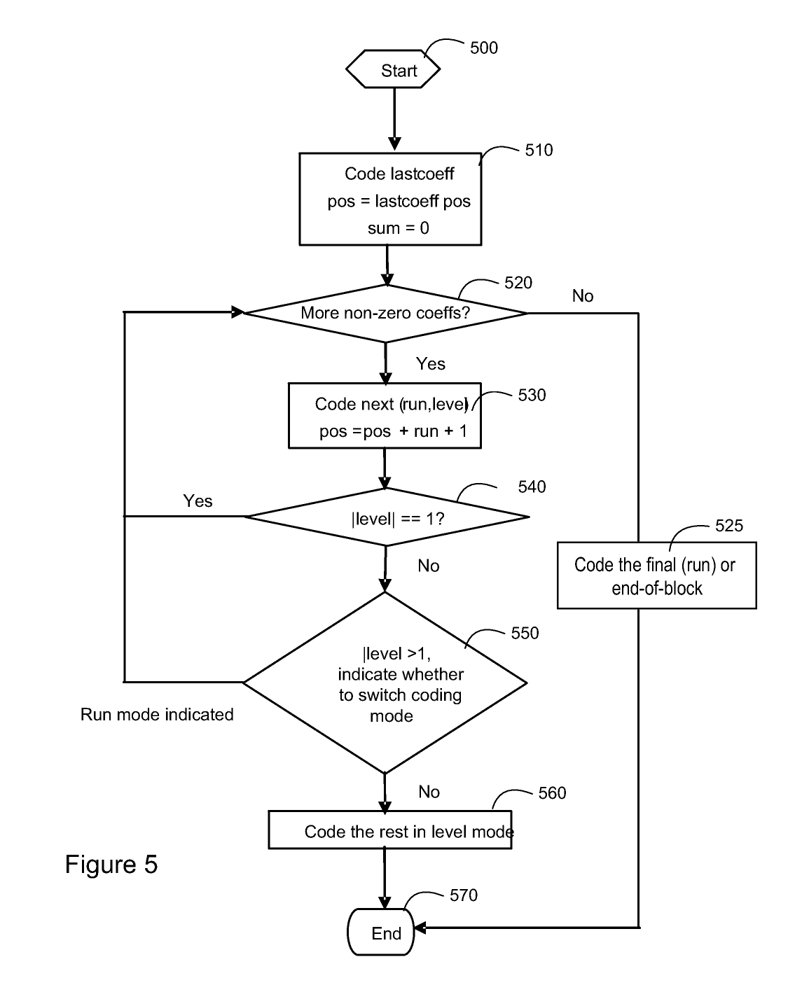

As described above, various embodiments allow for adaptively deciding when to switch from, e.g., run mode to level mode, based upon an explicit signal indicating whether or not modes should be switched. FIG. 5 illustrates processes performed in accordance with another embodiment, where the switching position is explicitly signaled by sending a syntax element in the bitstream that indicates whether the coder should continue in run mode or switch to level mode. At 500, the operation of coding starts. At 510, the position and value of a last non-zero coefficient of a block is coded. It should be noted that this particular coding of the last non-zero coefficient of the block is not coded according to either a run or level coding mode. At 520, it is determined whether there are remaining non-zero coefficients to be coded. If there are no more coefficients to be coded, the final (run) or end-of-block is coded at 525, and the operation is stopped at 570. At 530, if more coefficients exist, the next coefficient grouping, e.g., (run,level) pair, is coded. At 540, it is determined whether the amplitude of the current level is equal to 1, and if so, the operation returns to 520 and the next pair is coded at 530. A different amplitude threshold value than “1” may be used at 540 and subsequent processes. If the amplitude of the current level does not equal 1, at 550, it is determined whether the amplitude of the current level is bigger than 1. If the amplitude of the current level is greater than 1, it is indicated in the bitstream whether the coder should continue in the run mode or switch to level mode. If the run mode is indicated, then the operation returns to 530 and the next pair is coded. Otherwise, at 560, the rest of the remaining coefficients are coded in level mode. Once no more coefficients remain to be coded, the operation is stopped at 570.

There are different methods of coding the switching indication in the bistream in accordance with various embodiments. For example, an indication can be implemented as a single bit stored in the bitstream. Alternatively, the indication can be combined with one or more other coding elements.

Various embodiments described herein improve earlier solutions to coding transform coefficients by defining more accurately, the position where switching from one coding mode to another should occur. This in turn improves coding efficiency. Signaling the switching position explicitly further enhances coding efficiency by directly notifying the coder where to switch coding modes.

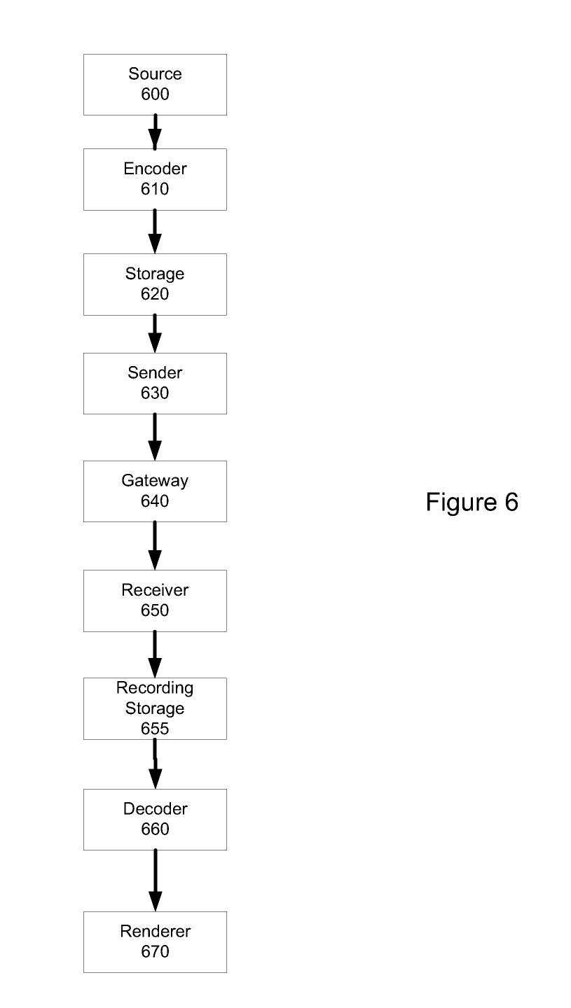

FIG. 6 is a graphical representation of a generic multimedia communication system within which various embodiments may be implemented. As shown in FIG. 6, a data source 600 provides a source signal in an analog, uncompressed digital, or compressed digital format, or any combination of these formats. An encoder 610 encodes the source signal into a coded media bitstream. It should be noted that a bitstream to be decoded can be received directly or indirectly from a remote device located within virtually any type of network. Additionally, the bitstream can be received from local hardware or software. The encoder 610 may be capable of encoding more than one media type, such as audio and video, or more than one encoder 610 may be required to code different media types of the source signal. The encoder 610 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 6 only one encoder 610 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 620. The storage 620 may comprise any type of mass memory to store the coded media bitstream. The format of the coded media bitstream in the storage 620 may be an elementary self-contained bitstream format, or one or more coded media bitstreams may be encapsulated into a container file. Some systems operate “live”, i.e. omit storage and transfer coded media bitstream from the encoder 610 directly to the sender 630. The coded media bitstream is then transferred to the sender 630, also referred to as the server, on a need basis. The format used in the transmission may be an elementary self-contained bitstream format, a packet stream format, or one or more coded media bitstreams may be encapsulated into a container file. The encoder 610, the storage 620, and the server 630 may reside in the same physical device or they may be included in separate devices. The encoder 610 and server 630 may operate with live real-time content, in which case the coded media bitstream is typically not stored permanently, but rather buffered for small periods of time in the content encoder 610 and/or in the server 630 to smooth out variations in processing delay, transfer delay, and coded media bitrate.

The server 630 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 630 encapsulates the coded media bitstream into packets. For example, when RTP is used, the server 630 encapsulates the coded media bitstream into RTP packets according to an RTP payload format. Typically, each media type has a dedicated RTP payload format. It should be again noted that a system may contain more than one server 630, but for the sake of simplicity, the following description only considers one server 630.

The server 630 may or may not be connected to a gateway 640 through a communication network. The gateway 640 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 640 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 640 is called an RTP mixer or an RTP translator and typically acts as an endpoint of an RTP connection.

The system includes one or more receivers 650, typically capable of receiving, de-modulating, and de-capsulating the transmitted signal into a coded media bitstream. The coded media bitstream is transferred to a recording storage 655. The recording storage 655 may comprise any type of mass memory to store the coded media bitstream. The recording storage 655 may alternatively or additively comprise computation memory, such as random access memory. The format of the coded media bitstream in the recording storage 655 may be an elementary self-contained bitstream format, or one or more coded media bitstreams may be encapsulated into a container file. If there are multiple coded media bitstreams, such as an audio stream and a video stream, associated with each other, a container file is typically used and the receiver 650 comprises or is attached to a container file generator producing a container file from input streams. Some systems operate “live,” i.e. omit the recording storage 655 and transfer coded media bitstream from the receiver 650 directly to the decoder 660. In some systems, only the most recent part of the recorded stream, e.g., the most recent 10-minute excerption of the recorded stream, is maintained in the recording storage 655, while any earlier recorded data is discarded from the recording storage 655.

The coded media bitstream is transferred from the recording storage 655 to the decoder 660. If there are many coded media bitstreams, such as an audio stream and a video stream, associated with each other and encapsulated into a container file, a file parser (not shown in the figure) is used to decapsulate each coded media bitstream from the container file. The recording storage 655 or a decoder 660 may comprise the file parser, or the file parser is attached to either recording storage 655 or the decoder 660.

The coded media bitstream is typically processed further by a decoder 660, whose output is one or more uncompressed media streams. Finally, a renderer 670 may reproduce the uncompressed media streams with a loudspeaker or a display, for example. The receiver 650, recording storage 655, decoder 660, and renderer 670 may reside in the same physical device or they may be included in separate devices.

A sender 630 according to various embodiments may be configured to select the transmitted layers for multiple reasons, such as to respond to requests of the receiver 650 or prevailing conditions of the network over which the bitstream is conveyed. A request from the receiver can be, e.g., a request for a change of layers for display or a change of a rendering device having different capabilities compared to the previous one.

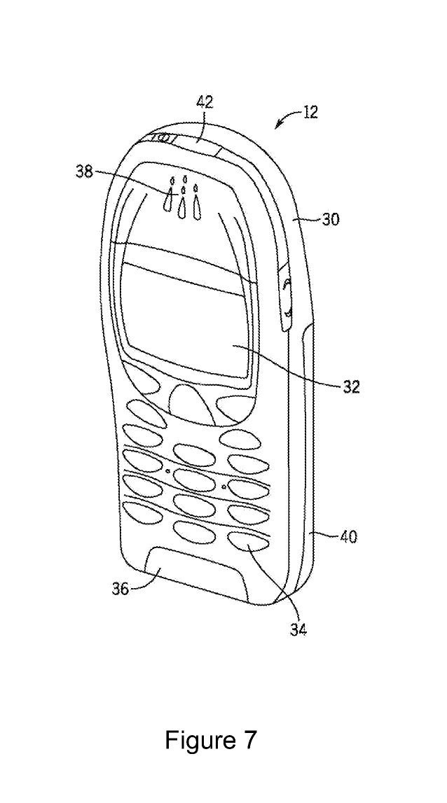

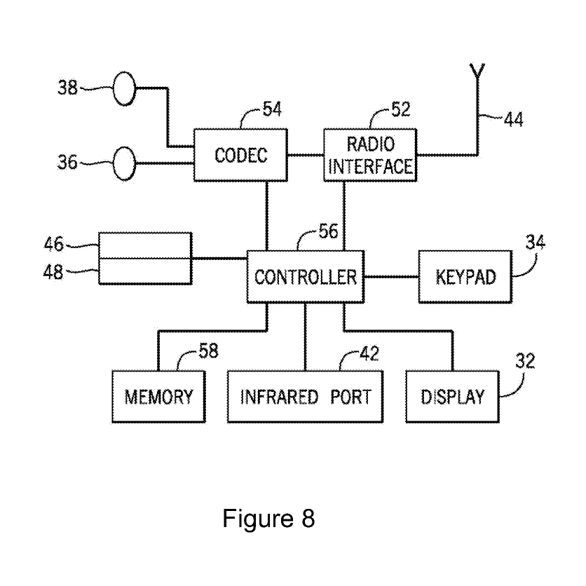

FIGS. 7 and 8 show one representative electronic device 12 within which the present invention may be implemented. It should be understood, however, that the present invention is not intended to be limited to one particular type of device. The electronic device 12 of FIGS. 7 and 8 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
encoding position and value of a last non-zero coefficient of a block;
coding at least one coefficient in accordance with a first coding mode when an amplitude of the at least one coefficient is less than or equal to a threshold; and
determining a cumulative sum of amplitudes of previously coded non-zero coefficients that are greater than the threshold; and
wherein when the cumulative sum is less than a cumulative threshold value, and the position of the latest non-zero coefficient is less than a location threshold:
coding a subsequent coefficient in accordance with the first coding mode;
otherwise, coding a subsequent coefficient in accordance with a second coding mode.

2. The method of claim 1, wherein the first coding mode comprises a run coding mode configure to code the at least one coefficient in groups, and wherein the groups comprise run and level pairs.

3. The method of claim 1, wherein the second coding mode comprises a level coding mode configured to code coefficients one at a time.

4. The method of claim 1, wherein the cumulative threshold value depends at least on a quantization parameter used in coding the block.

5. The method of claim 1, wherein the cumulative sum of amplitudes of the previously coded non-zero coefficients that are greater than the threshold is larger than the cumulative threshold value when at least a maximum occurrence threshold is met for any possible amplitude value of one of the previously coded non-zero coefficients.

6. A computer-readable medium having a computer program stored thereon, the computer program comprising instructions operable to cause a processor to perform method of claim 1.

7. An apparatus, comprising a processor configured to:
encode position and value of a last non-zero coefficient of a block;
code at least one coefficient in accordance with a first coding mode when an amplitude of the at least one coefficient is less than or equal to a threshold; and
determine a cumulative sum of amplitudes of previously coded non-zero coefficients that are greater than the threshold; and
wherein when the cumulative sum is less than a cumulative threshold value, and the position of the latest non-zero coefficient is less than a location threshold:
code a subsequent coefficient in accordance with the first coding mode;
otherwise, code a subsequent coefficient in accordance with a second coding mode.

8. The apparatus of claim 7, wherein the first coding mode comprises a run coding mode configure to code the at least one coefficient in groups, and wherein the groups comprise run and level pairs.

9. The apparatus of claim 7, wherein the second coding mode comprises a level coding mode configured to code coefficients one at a time.

10. The apparatus of claim 7, wherein the cumulative threshold value depends at least on a quantization parameter used in coding the block.

11. The apparatus of claim 7, wherein the cumulative sum of amplitudes of the previously coded non-zero coefficients that are greater than the threshold is larger than the cumulative threshold value when at least a maximum occurrence threshold is met for any possible amplitude value of one of the previously coded non-zero coefficients.

12. A method, comprising:
decoding position and value of a last non-zero coefficient of a block in a coded bitstream;
decoding at least one quantized transform coefficient from the coded bitstream in accordance with at least one of a first coding mode and a second coding mode, wherein the decoding results in one of a:
a quantized coefficient group coded in accordance with the first coding mode, wherein a cumulative sum of amplitudes of previously coded non-zero coefficients that are greater than a threshold is less than a cumulative threshold value, and a position of a latest non-zero coefficient is less than a location threshold; and
a quantized coefficient coded in accordance with the second coding mode, wherein one of the cumulative sum of amplitudes of previously coded non-zero coefficients that are greater than the threshold is one of equal to and greater than the cumulative threshold value, and the position of the latest non-zero coefficient is one of equal to and greater than the location threshold.

13. The method of claim 12, wherein the first coding mode comprises a run coding mode configure to code coefficients in groups, and wherein the groups comprise run and level pairs.

14. The method of claim 12, wherein the second coding mode comprises a level coding mode configured to code coefficients one at a time.

15. The method of claim 12, wherein the cumulative threshold value depends on a quantization parameter used in coding the block.

16. The method of claim 12, wherein the cumulative sum of amplitudes of the previously coded non-zero coefficients that are greater than the threshold is larger than the cumulative threshold value when at least a maximum occurrence threshold is met for any possible amplitude value of one of the previously coded non-zero coefficients.

17. A computer-readable medium having a computer program stored thereon, the computer program comprising instructions operable to cause a processor to perform method of claim 12.

18. An apparatus, comprising:
a processor configured to:
decode position and value of a last non-zero coefficient of a block in a coded bitstream;
decode at least one quantized transform coefficient from the coded bitstream in accordance with at least one of a first coding mode and a second coding mode, wherein the decoding results in one of a:
a quantized coefficient group coded in accordance with the first coding mode, wherein a cumulative sum of amplitudes of previously coded non-zero coefficients that are greater than a threshold is less than a cumulative threshold value, and a position of a latest non-zero coefficient is less than a location threshold; and
a quantized coefficient coded in accordance with the second coding mode, wherein one of the cumulative sum of amplitudes of previously coded non-zero coefficients that are greater than the threshold is one of equal to and greater than the cumulative threshold value, and the position of the latest non-zero coefficient is one of equal to and greater than the location threshold; and
output a block of quantized coefficients including at least one of the quantized coefficient group and the quantized coefficient.

19. The apparatus of claim 18, wherein the first coding mode comprises a run coding mode configure to code coefficients in groups, and wherein the groups comprise run and level pairs.

20. The apparatus of claim 18, wherein the second coding mode comprises a level coding mode configured to code coefficients one at a time.

21. The apparatus of claim 18, wherein the cumulative threshold value depends on a quantization parameter used in coding the block.

22. The apparatus of claim 18, wherein the cumulative sum of amplitudes of the previously coded non-zero coefficients that are greater than the threshold is larger than the cumulative threshold value when at least a maximum occurrence threshold is met for any possible amplitude value of one of the previously coded non-zero coefficients
